(19) United States
(12) Patent Application Publication
(10) Pub. No.: US 2022/0137450 A1
(43) Pub. Date: May 5, 2022

(54) METHODS FOR FABRICATING LIQUID CRYSTAL POLARIZERS

(71) Applicant: SHARP KABUSHIKI KAISHA, Osaka (JP)

(72) Inventors: NATHAN JAMES SMITH, Oxford (GB); JACK WEST, Oxford (GB); ANDREW ACREMAN, Oxford (GB)

(21) Appl. No.: 17/089,655

(22) Filed: Nov. 4, 2020

(51) Int. Cl. G02F 1/1335; G02F 1/13357; G02F 1/13363; G02F 1/1337

(52) U.S. Cl. CPC G02F 1/133516; G02F 1/133528; G02F 2001/133638; G02F 1/13363; G02F 1/1337; G02F 1/133602

(57) ABSTRACT

A liquid crystal display (LCD) apparatus that has increased contrast in displayed images, from the viewing side includes; a first external linear polarizer layer having a transmission axis aligned along in a first direction, a color filter substrate layer. A patterned color filter layer including individual color filters, a guest-host in-cell polarizer alignment layer an in-cell guest-host polarizer layer having a transmission axis aligned along the first direction, a first liquid crystal (LC) alignment layer, an LC layer, a second LC alignment layer, a first electrode layer, a thin film transistor (TFT) substrate layer, a second external polarizer layer having a transmission axis aligned along a second direction perpendicular to the first direction, and a backlight unit configured for illuminating the LCD apparatus.

### FIELD

The present disclosure relates to fabrication techniques of thin liquid crystal (LC) polarizers for use with display devices.

### BACKGROUND

Conventional linear polarizers used for display applications include a uniaxial stretched poly(vinyl alcohol) that has been impregnated with iodine or doped with dichroic dyes. Conventional linear polarizers exhibit excellent dichroic ratios (typically >50) but are relatively thick (about 100 μm). The thickness of conventional polarizers precludes their use for in-cell LCD applications in which a polarizer is deposited between substrates that form an LC cell.

Thinner linear polarizers that use a guest-host liquid crystal mixture have been proposed to address the thickness problem of conventional polarizers. A guest-host liquid crystal polarizer includes a dichroic dye “guest” and an LC “host” in which the LC host aligns the dichroic dye in a predetermined direction. The LC host may be a reactive mesogen (RM).

An RM is an LC that can be polymerized in order to form a solid film. The terms LC and RM may be used interchangeably. A guest-host LC polarizer layer is typically 1-10 μm thick excluding substrate(s).

European Patent Office Patent No. EP2077463A1 to Hekstra et al. (hereinafter “Hekstra”), describes the use of an in-cell guest-host polarizer to improve the contrast ratio of an LCD. The LCD in Hekstra comprises a polarizer, a glass layer, a color filter layer comprised of red, green, blue and yellow color filters, an in-cell polarizer, a first electrode layer, an LC layer, a second electrode layer, a glass layer and a polarizer. The in-cell guest-host polarizer layer further includes a red in-cell guest-host polarizer, a green in-cell guest-host polarizer, a blue in-cell guest-host polarizer, and a yellow in-cell guest-host polarizer.

Hekstra also describes that the in-cell polarizer may be located between the liquid crystal and the electrode. However, Hekstra fails to teach how to align the in-cell guest-host polarizer, and fails to teach how to align the liquid crystal layer without damaging the in-cell guest-host polarizer. Hekstra also fails to teach the use and deposition of retarder layers to compensate for unwanted off-axis effects caused by the in-cell guest-host polarizer. There is a need for a liquid crystal polarizer that avoids these problems.

Other patents and published applications disclosing guest-host polarizers include WO2005/045485A1, U.S. Pat. No. 8,518,299B2, EP1682930B1, EP2159611B1, and EP1899751B1.

### SUMMARY

A viewable liquid crystal display (LCD) apparatus having improved image contrast includes, from the viewing side, a first external linear polarizer layer having a transmission axis aligned along in a first direction, a color filter substrate layer, a patterned color filter layer, a guest-host in-cell polarizer alignment layer, an in-cell guest-host polarizer layer having a transmission axis aligned along the first direction, a first liquid crystal (LC) alignment layer, an LC layer, a second LC alignment layer, a first electrode layer, a thin film transistor (TFT) substrate layer, a second external polarizer layer having a transmission axis aligned along a second direction perpendicular to the first direction, and a backlight unit. The patterned color filter layer includes individual color filters, and the backlight unit is configured to illuminate the LCD apparatus through the LC layer and the patterned color filter layer, among other layers, for viewing.

Preferably the first LC alignment layer is configured such that it has a baking process temperature of less than 180 degrees Celsius. The first electrode layer may include both a first electrode and a second electrode that is electrically isolated form the first electrode, such that only the first electrode layer is needed for controlling the LC layer. Alternatively, the LCD apparatus may include a second electrode layer, with the LC layer formed between the first electrode layer and the second electrode layer. Alternatively, the LCD apparatus may include a second electrode layer, but with the LC layer formed over the first electrode layer and the second electrode layer (i.e., with the first electrode layer formed between the second electrode layer and the LC layer).

In one implementation, the in-cell guest-host polarizer layer is patterned with individual dye components. The dye components are aligned with the color filters of the patterned color filter layer to reduce color artifacts as compared to an unpatterned guest-host polarizer. In other implementations having patterned color filter layers, individual dye components may cover two or more color filters of the patterned color filter layer to lower manufacturing costs compared with a patterned in-cell guest-host polarizer layer wherein each dye component corresponds to an individual color filter layer.

The in-cell guest-host polarizer layer may be made from a material having multiple guest reactive groups and multiple host reactive groups to enable a more mechanically robust solid guest-host polarizer layer to be formed after polymerization. In some implementations, the in-cell guest-host polarizer layer comprises a material having a plurality of guest molecules. In some implementations the plurality of guest molecules may be individually configured to absorb polarized light in a plurality of wavelengths.

In such an implementation, the first type of guest molecule absorbs light polarized parallel to the guest molecule's absorption axis for a first wavelength range wherein the first wavelength range partially, but not fully, covers the visible spectrum. And the second type of guest molecule absorb light polarized parallel to the guest molecule's absorption axis for a second wavelength range wherein the second wavelength range partially, but not fully, covers the visible spectrum.

In one implementation, the LCD apparatus also includes an in-cell retarder layer configured to negate off-axis birefringence from the in-cell guest-host polarizer layer. In one implementation, the LCD apparatus also includes an out-cell retarder layer configured to negate off-axis birefringence from the in-cell guest-host polarizer layer. The in-cell and out-cell retarder layers reduce light travelling off-axis, which may degrade the image quality of the LCD apparatus, by degrading the contrast ratio of the LCD apparatus.

In one implementation, the LCD apparatus includes an out-cell quarter wave plate (λ/4) retarder having an optical axis arranged at an azimuth angle ϕ=+45°, and an in-cell quarter wave plate (λ/4) retarder having an optical axis arranged at an azimuth angle ϕ=−45°. The retardation and dispersion of the out-cell quarter wave plate retarder and the in-cell quarter wave plate retarder are preferably substantially the same.

In another implementation, a viewable liquid crystal display (LCD) apparatus having increased contrast includes, from the viewing side, a first external polarizer having a transmission axis arranged in a first direction, a color filter substrate, a patterned color filter layer, the pattern including individual color filters, an in-cell guest-host polarizer alignment layer, an in-cell guest-host polarizer layer having a transmission axis aligned along the first direction and configured to align a liquid crystal (LC) layer, a liquid crystal (LC) layer, an LC alignment layer, a first electrode layer, a thin film transistor (TFT) substrate layer, a second external polarizer layer having a transmission axis arranged in a second direction perpendicular to the first direction, and a backlight unit. In this implementation, the in-cell guest-host polarizer layer and the alignment layer serve to align the LC layer, as opposed to having two LC alignment layers.

Similar to the other implementations, the first electrode layer may include both a cathode electrode and an anode electrode, the LCD apparatus may include a second electrode layer with the LC layer placed between the first electrode layer and the second electrode layer, or may include a second electrode layer with the first electrode layer disposed between the LC layer and the second electrode layer.

Similar to the other implementations, the in-cell guest-host polarizer layer may be patterned with individual dye components, the dye components individually aligned with the color filters of the patterned color filter layer, or individual dye components may align across two or more color filters.

Similar to the other embodiments, the in-cell guest-host polarizer layer may comprise a material having guest reactive groups and host reactive groups. The in-cell guest-host polarizer layer may include a material having a plurality of guest molecules, and the plurality of guest molecules are preferably configured for absorbing polarized light in a plurality of wavelengths.

In another implementation, the LCD apparatus includes a retarder layer chosen from the list consisting of a biaxial retarder, a positive A-plate retarder, a negative A-plate retarder, a positive C-plate retarder, and a negative C-plate retarder. An axis of the biaxial retarder is arranged either parallel or perpendicular to the transmission axis of the guest-host polarizer layer, an axis of the positive A-plate retarder(s) is arranged either parallel or perpendicular to the transmission axis of the guest-host polarizer layer, and an axis of the negative A-plate retarder(s) is arranged either parallel or perpendicular to the transmission axis of the guest-host polarizer layer.

### BRIEF DESCRIPTION OF THE DRAWINGS

Aspects of the exemplary disclosure are best understood from the following detailed description when read with the accompanying figures. Various features are not drawn to scale, dimensions of various features may be arbitrarily increased or reduced for clarity of discussion.

FIG. 1 illustrates a section elevation view of a first implementation prior art in-cell guest-host polarizer.

FIG. 2 illustrates a section elevation view of a second implementation prior art in-cell guest-host polarizer.

FIG. 3 illustrates LC angles in a coordinate system to which the present disclosure is directed.

FIG. 4 illustrates angles of the coordinate system of FIG. 3.

FIG. 5 illustrates an LCD with an in-cell guest-host polarizer configured to increase the contrast ratio of the LCD in accordance with an example implementation of the present disclosure.

FIG. 6 illustrates an LCD with an in-cell guest-host polarizer configured to increase the contrast ratio of the LCD in accordance with another example implementation of the present disclosure.

FIG. 7 illustrates an LCD with an in-cell guest-host polarizer configured to increase the contrast ratio of the LCD in accordance with yet another example implementation of the present disclosure.

FIG. 8 illustrates an LCD with an in-cell guest-host polarizer configured to increase the contrast ratio of the LCD in accordance with yet another example implementation of the present disclosure.

FIG. 9 illustrates an LCD with an in-cell guest-host polarizer configured to increase the contrast ratio of the LCD in accordance with yet another example implementation of the present disclosure.

FIG. 10 illustrates an LCD with an in-cell guest-host polarizer configured to increase the contrast ratio of the LCD in accordance with yet another example implementation of the present disclosure.

FIG. 11 illustrates an LCD with a dye component having a patterned in-cell guest-host polarizer layer in accordance with an example implementation of the present disclosure.

FIG. 12 illustrates an LCD with a dye component having a patterned in-cell guest-host polarizer layer in accordance with another example implementation of the present disclosure.

FIG. 13 illustrates an LCD with a dye component having a patterned in-cell guest-host polarizer layer in accordance with yet another example implementation of the present disclosure.

FIG. 14 illustrates an LCD with dye component having a patterned in-cell guest-host polarizer layer in accordance with yet another example implementation of the present disclosure.

FIG. 15 illustrates an LCD with dye component having a patterned in-cell guest-host polarizer layer in accordance with yet another example implementation of the present disclosure.

FIG. 16 illustrates an LCD with dye component having a patterned in-cell guest-host polarizer layer in accordance with yet another example implementation of the present disclosure.

FIG. 17 illustrates an LCD with dye component having a patterned in-cell guest-host polarizer layer in accordance with yet another example implementation of the present disclosure.

FIG. 18 illustrates an LCD with dye component having a patterned in-cell guest-host polarizer layer in accordance with yet another example implementation of the present disclosure.

FIG. 19 illustrates a guest-host polarizer material in both a non-polymerized state and a polymerized state in accordance with an example implementation of the present disclosure.

FIG. 20 illustrates a guest-host polarizer material in both a non-polymerized state and a polymerized state in accordance with another example implementation of the present disclosure.

FIG. 21 illustrates a guest-host polarizer material in both a non-polymerized state and a polymerized state in accordance with yet another example implementation of the present disclosure.

FIG. 22 illustrates an LCD with an in-cell retarder layer in accordance with an example implementation of the present disclosure.

FIG. 23 illustrates an LCD with an in-cell retarder layer in accordance with another example implementation of the present disclosure.

FIG. 24 illustrates an LCD with an in-cell retarder layer in accordance with yet another example implementation of the present disclosure.

FIG. 25 illustrates an LCD with an in-cell retarder layer in accordance with yet another example implementation of the present disclosure.

FIG. 26 illustrates an LCD with an out-cell retarder layer in accordance with yet another example implementation of the present disclosure.

FIG. 27 illustrates an LCD with an out-cell retarder layer in accordance with yet another example implementation of the present disclosure.

FIG. 28 illustrates a high-contrast low-reflectivity LCD in accordance with an example implementation of the present disclosure.

FIG. 29 illustrates a high-contrast low-reflectivity LCD in accordance with another example implementation of the present disclosure.

### DESCRIPTION

The following description contains specific information pertaining to exemplary implementations of the present disclosure. The drawings in the present disclosure and their accompanying detailed description are directed to merely exemplary implementations. However, the present disclosure is not limited to merely these exemplary implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale, and are not intended to correspond to actual relative dimensions

For consistency and ease of understanding, like features are identified (although, in some examples, not shown) by numerals in the exemplary figures. However, the features in different implementations may differ in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates an open-ended inclusion or membership in the so-described combination, group, series and the equivalent.

Additionally, for purposes of explanation and non-limitation, specific details, such as functional entities, techniques, protocols, standards, and the like are set forth for providing an understanding of the described technology. In other examples, detailed description of well-known methods, technologies, system, architectures, and the like are omitted so as not to obscure the description with unnecessary details.

Implementations of the present disclosure will be described with reference to the drawings in which reference numerals are used to refer to like elements throughout. It will be understood that the figures are not necessarily to scale.

The present disclosure provides a manufacturing method for a high-quality guest-host liquid crystal polarizer in which the host is a smectic phase liquid crystal. The manufacturing methods achieve a guest-host polarizer on a single substrate in order to reduce thickness.

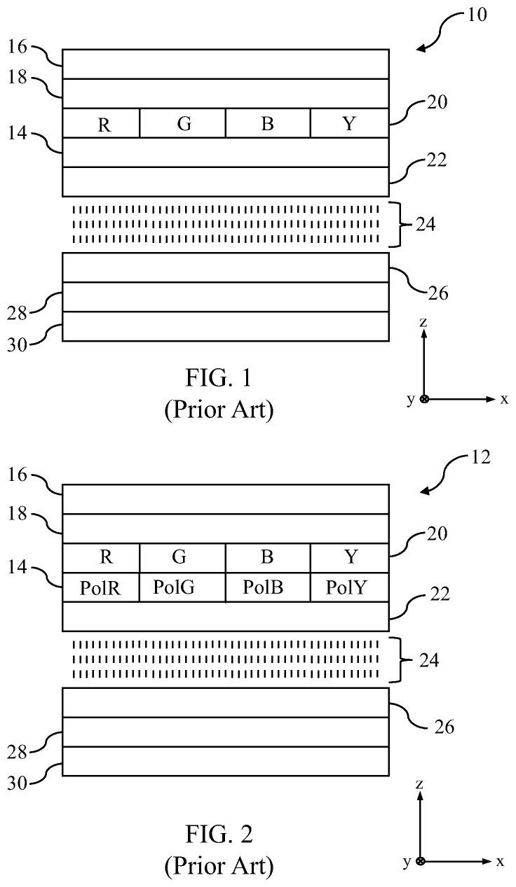

With reference to FIGS. 1 and 2, the aforementioned prior art to Hekstra describes an in-cell guest host polarizer in a first implementation LCD 10 and a second implementation LCD 12. With reference to FIG. 1, the first implementation 10 uses an in-cell guest-host polarizer 14 to improve the contrast ratio of the LCD 10. The first implementation LCD 10 also comprises a top polarizer 16, an upper glass layer 18, a color filter layer 20 comprising individual red (R), green (G), blue (B) and yellow (Y) color filters, the in-cell guest-host polarizer 14, a first electrode layer 22, a liquid crystal layer 24 (hereinafter, “LC layer”), a second electrode layer 26, a lower glass layer 28 and a bottom polarizer 30.

With reference to FIG. 2, in the second implementation LCD 12, the structure is essentially the same, except that the in-cell guest-host polarizer 14 comprises a red in-cell guest-host polarizer (POLR), a green in-cell guest-host polarizer (POLG), a blue in-cell guest-host polarizer (POLB) and a yellow in-cell guest-host polarizer (POLY), aligned with, and corresponding to, the colors in the color filter layer 20.

Hekstra also describes that the in-cell guest-host polarizer 14 may be located between the LC layer 24 and the first electrode layer 22 (not shown). As discussed, Hekstra fails to teach how to align the in-cell guest-host polarizer 14, and how to align the LC layer 24 without damaging the in-cell guest-host polarizer 14, and fails to teach the use and deposition of retarder layers to compensate for unwanted off-axis effects caused by the in-cell guest-host polarizer 14.

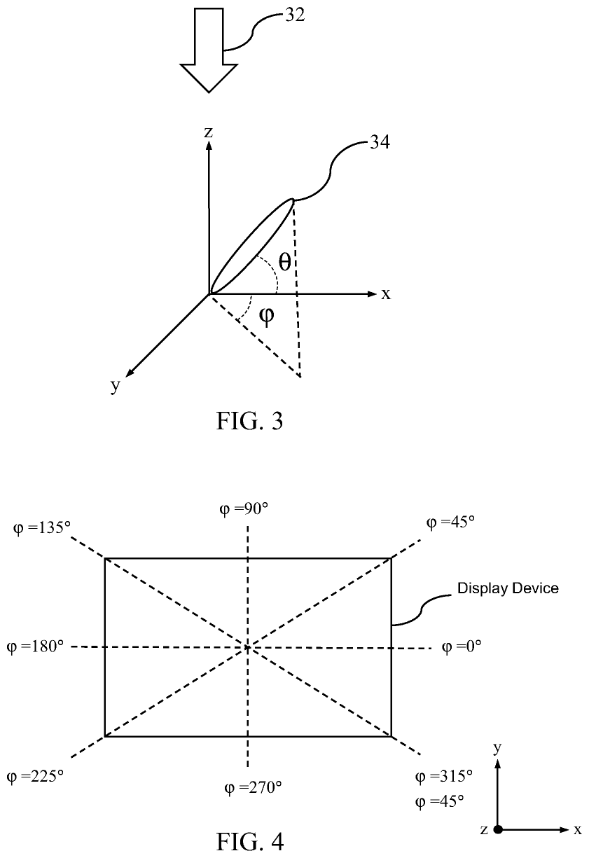

FIGS. 3 and 4 illustrate angles in a coordinate system for providing pertinent terms of orientation used in this disclosure. FIG. 3 illustrates angles of the coordinate system of FIGS. 1 and 2, and that the axes x, y and z are orthogonal to each other including the top down (z axis), which is a viewing direction 32 typical of LC displays. The angle between the x-axis and the y-axis is defined as the in-plane angle φ with the term “in-plane” signifying being in the plane of a display device (not shown). The angle between the x-axis (or y-axis) and the z-axis is the out-of-plane angle θ relative to the plane of the display device. Additionally, FIG. 3 shows a rod-shaped LC molecule 34 oriented within an RM guest-host polarizer layer.

FIG. 4 shows a range of positioning of the in-plane angle φ with respect to a display device from the perspective of the z axis viewing direction 32 (FIG. 3) related to a generalized polarizer film and display device (not shown). Planar alignment of the rod-shaped LC molecule 34 (FIG. 3) occurs when the rod-shaped LC molecule 34 is substantially constrained to the x-y plane (i.e., out-of-plane angle θ<10°). Planar alignment of the rod-shaped LC molecule 34 occurs when it has a uniform in-plane alignment angle cp. Vertical alignment of the rod-shaped LC molecule 34 occurs when it has an out-of-plane angle θ that is approximately 90°.

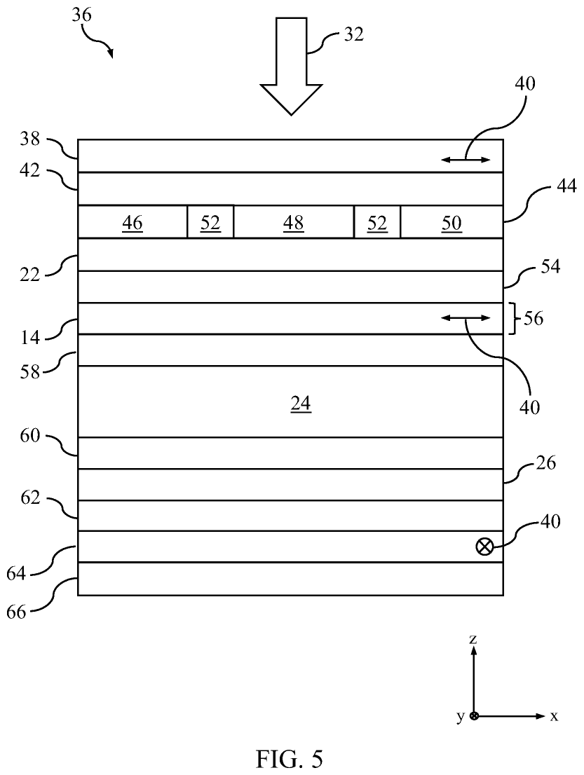

FIG. 5 shows a first LCD 36 with an in-cell guest-host polarizer 14 configured to increase the contrast ratio of the first LCD 36. From the viewing direction 32, the first LCD 36 with in-cell guest-host polarizer 14 comprises a first external linear polarizer 38 with a transmission axis 40 aligned parallel to the x-direction, a color filter substrate layer 42, a patterned color filter layer 44 (in the exemplary illustrated implementation comprised of a red color filter 46, a green color filter 48, a blue color filter 50, and a black mask 52 patterned in an arrangement separating the color filters), a first electrode layer 22, a guest-host polarizer alignment layer 54 that aligns the transmission axis 40 of the in-cell guest-host polarizer 14 parallel to the x-direction, the in-cell guest-host polarizer 14 having a first predetermined thickness 56, a first LC alignment layer 58, an LC layer 24, a second LC alignment layer 60, a second electrode layer 26, a thin film transistor (TFT) substrate 62 (the TFT substrate 62 is comprised of a substrate with a conventional arrangement of TFTs and drive electrodes for switching pixels of the LC layer 24), a second external polarizer 64 with transmission axis 40 aligned parallel to the y-direction (i.e., into the plane of the page), and, a backlight unit 66.

In the in-cell guest-host polarizer 14, the host material is preferably a polymerized material, such as a reactive mesogen (RM), and the guest material is preferably a dichroic dye or mixture of different dichroic dyes. The first LC alignment layer 58 preferably comprises a material that does not degrade the optical properties of the in-cell guest-host polarizer 14. The first LC alignment layer 58 is preferably also deposited and processed according to a method that does not degrade the optical properties (contrast ratio, dichroic ratio and transmission) of the in-cell guest-host polarizer 14. In particular, the baking time and baking temperature of the first LC alignment layer 58 preferably does not degrade the optical properties of the in-cell guest-host polarizer 14.

In accordance with implementations of the present disclosure, azo dyes (where the azo dye is the guest material) enable the best properties (i.e., high contrast ratio, high dichroic ratio and high transmission in a film of low thickness) in guest-host polarizers. And, the optical properties of azo dyes are best preserved when baked at temperatures below 180° C. and for up to about 20 minutes. Consequently, the baking temperature of the first LC alignment layer 58 may be less than 180° C. In another implementation, the baking temperature of the first LC alignment layer 58 may be less than 160° C. In yet another implementation, the baking temperature of the first LC alignment layer 58 may be less than 140° C.

The first LC alignment layer 58 and the second LC alignment layer 60 may align the LC material of the LC layer 24 substantially parallel to the z-axis (i.e., vertical alignment, θ>85°) to enable a conventional vertically aligned LC mode. The first LC alignment layer 58 and the second LC alignment layer 60 may align the LC material substantially parallel to the x-y plane (i.e., planar alignment, θ<10°. The first LC alignment layer 58 may align the LC layer 24 parallel to the x-axis or parallel to the y-axis. The second LC alignment layer 60 may align the LC layer 24 parallel to the x-axis or parallel to the y-axis. The alignment directions of the first LC alignment layer 58 and the second LC alignment layer 60 may have an anti-parallel arrangement that is conventionally used for IPS or FFS LC modes.

Alternatively, the first LC alignment layer 58 and the second LC alignment layer 60 may have a perpendicular arrangement to enable a 90° twisted nematic mode. The first LC alignment layer 58 and the second LC alignment layer 60 may enable an e-mode 90° twisted nematic mode wherein the alignment direction of the first LC alignment layer 58 is parallel to the transmission axis 40 of the first external linear polarizer 38 (and parallel to the transmission axis 40 of the in-cell guest-host polarizer 14) while the alignment direction of the second LC alignment layer 60 is parallel to the transmission axis 40 of the second external linear polarizer 64. The first LC alignment layer 58 and the second LC alignment layer 60 may enable an o-mode 90° twisted nematic mode wherein the alignment direction of the first LC alignment layer 58 is perpendicular to the transmission axis 40 of the first external linear polarizer 38 (and perpendicular to the transmission axis 40 of the in-cell guest-host polarizer 14) while the alignment direction of the second LC alignment layer 60 is perpendicular to the transmission axis 40 of the second external linear polarizer 64.

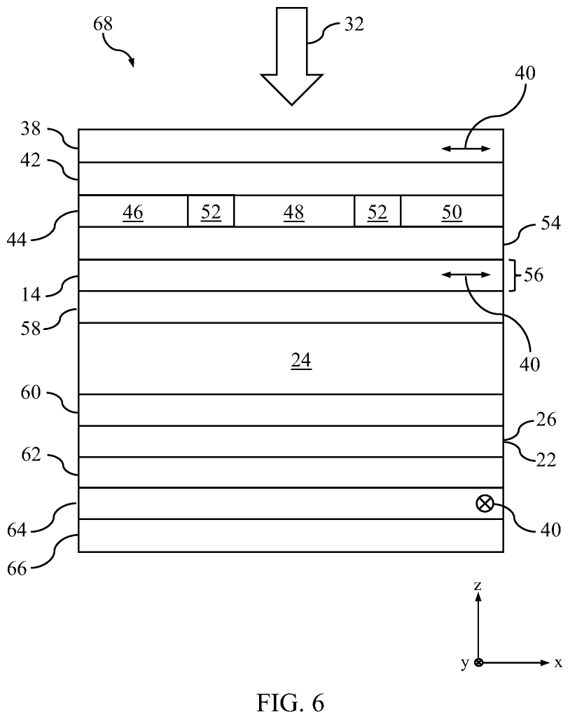

FIG. 6 shows a second LCD 68 with an in-cell guest-host polarizer 14 configured to increase the contrast ratio of the second LCD 68. The second LCD 68 and the first LCD 36 have different electrode arrangements but other features are common. In the second LCD 68, the first electrode layer 22 has a first electrode and the second electrode layer 26 has a second electrode wherein the first and second electrodes are electrically isolated from each other and interdigitated to enable an in-plane switching (IPS) LCD 68. The alignment direction of the first LC alignment layer 58 and the second LC alignment layer 60 may be arranged anti-parallel. Both the first LC alignment layer 58 and second LC alignment layer 60 may be arranged to align the LC layer 24 parallel to the x-axis. Alternatively, both the first LC alignment layer 58 and the second LC alignment layer 60 may be arranged to align the LC layer 24 parallel to the y-axis.

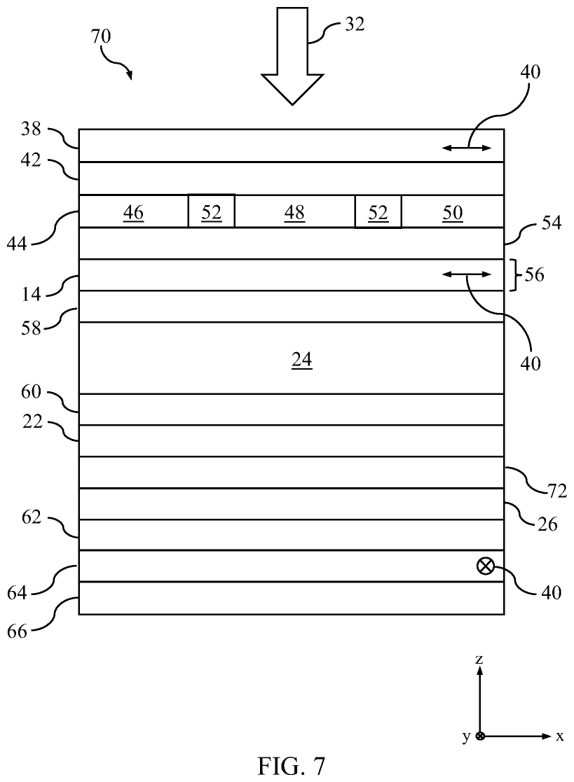

FIG. 7 shows a third LCD 70 with an in-cell guest-host polarizer 14 configured to increase the contrast ratio of the third LCD 70. The third LCD 70 and the first LCD 36 have different arrangements of electrodes but other features are common. In the third LCD 70, the first electrode layer 22 and the second electrode layer 26 are separated by an insulation layer 72 to enable conventional fringe field switching (FFS) in the third LCD 70. The alignment direction of the first LC alignment layer 58 and the second LC alignment layer 60 may be arranged anti-parallel. Both the first LC alignment layer 58 and second LC alignment layer 60 may be arranged to align the LC layer 24 parallel to the x-axis. Alternatively, both the first LC alignment layer 58 and the second LC alignment layer 60 may be arranged to align the LC layer 24 parallel to the y-axis.

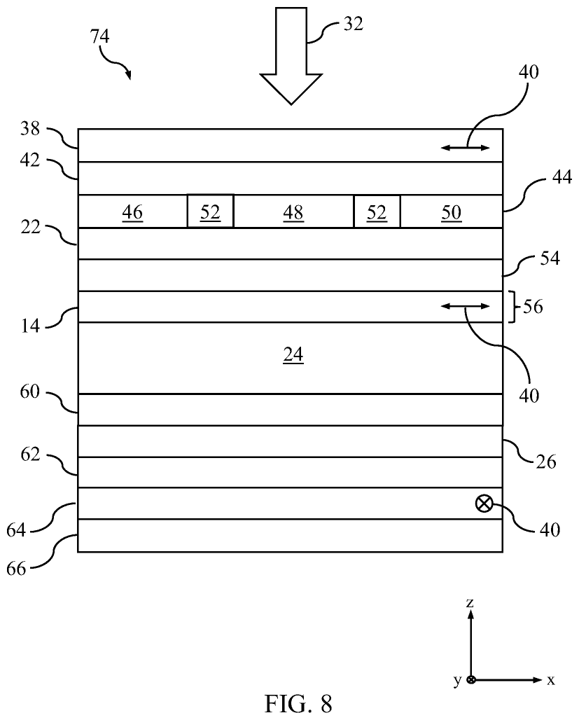

FIG. 8 shows a fourth LCD 74 with an in-cell guest-host polarizer 14 configured to increase the contrast ratio of the fourth LCD 74. The fourth LCD 74 is identical to the first LCD 36 except that the first LC alignment layer 58 (FIG. 1) has been removed (i.e., the second LC alignment layer 60 is the only LC alignment layer) and the in-cell guest-host polarizer 14 is configured to also perform an aligning function for the LC layer 24. Other features are common to the fourth LCD 74 and the first LCD 36. Removing the first LC alignment layer 58 (FIG. 1) has a first advantage of lower fabrication costs. Removing the first LC alignment layer 58 has a second advantage of removing processing conditions that may degrade the optical properties of the in-cell guest-host polarizer 14, in particular, the baking process associated with the first LC alignment layer 58 is no longer required.

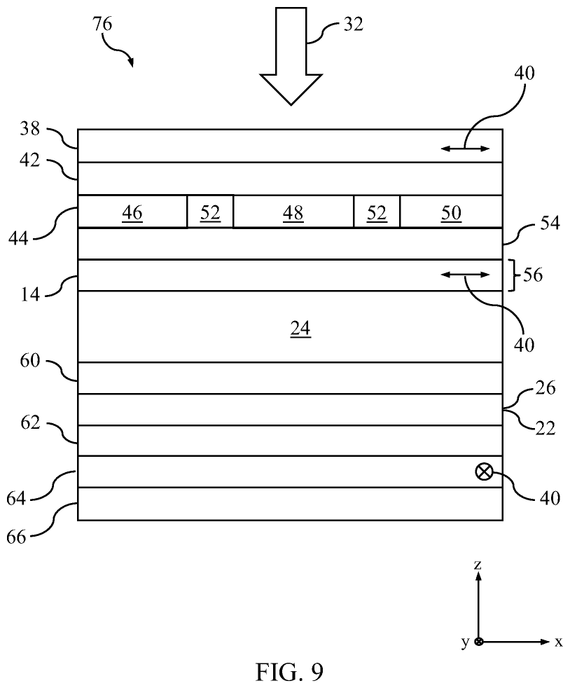

FIG. 9 shows a fifth LCD 76 with an in-cell guest-host polarizer 14 configured to increase the contrast ratio of the fifth LCD 76. The fifth LCD 76 is identical to the second LCD 68, except that the first LC alignment layer 58 has been removed and the in-cell guest-host polarizer 14 is configured to also perform an aligning function for the LC layer 24. Other features are common to the fifth LCD 76 and the second LCD 68. Removing the first LC alignment layer 58 (FIG. 6) has a first advantage of lower fabrication costs. Removing the first LC alignment layer 58 has a second advantage of removing processing conditions that may degrade the optical properties of the in-cell guest-host polarizer 14, in particular, the baking process associated with the first LC alignment layer 58 is no longer required.

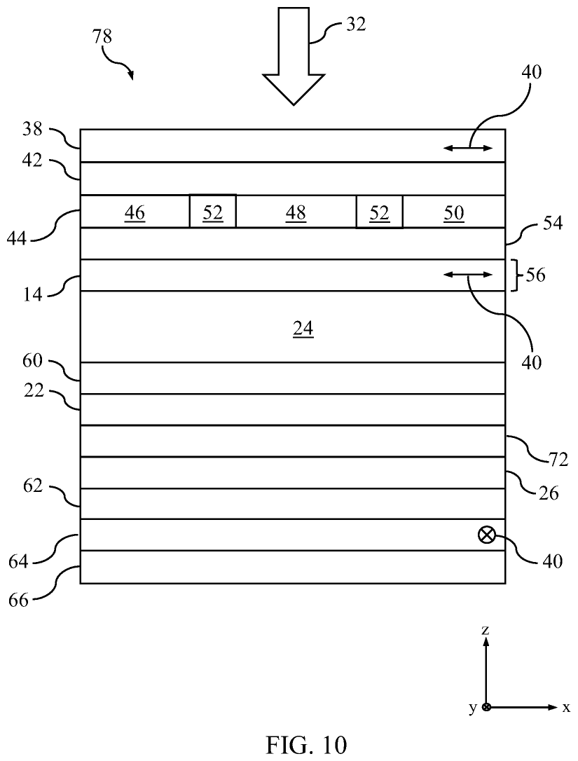

FIG. 10 shows a sixth LCD 78 with an in-cell guest-host polarizer 14 configured to increase the contrast ratio of the sixth LCD 78. The sixth LCD 78 is identical to the third LCD 70 except that the first LC alignment layer 58 (FIG. 7) has been removed and the in-cell guest-host polarizer 14 is configured to also perform an aligning function for the LC layer 24. Other features are common between the sixth LCD 78 and the third LCD 70. Removing the first LC alignment layer 58 has a first advantage of lower fabrication costs. Additionally, removing the first LC alignment layer 58 has a second advantage of removing processing conditions that may degrade the optical properties of the guest-host polarizer. In particular, the baking process associated with the first LC alignment layer 58 is no longer required.

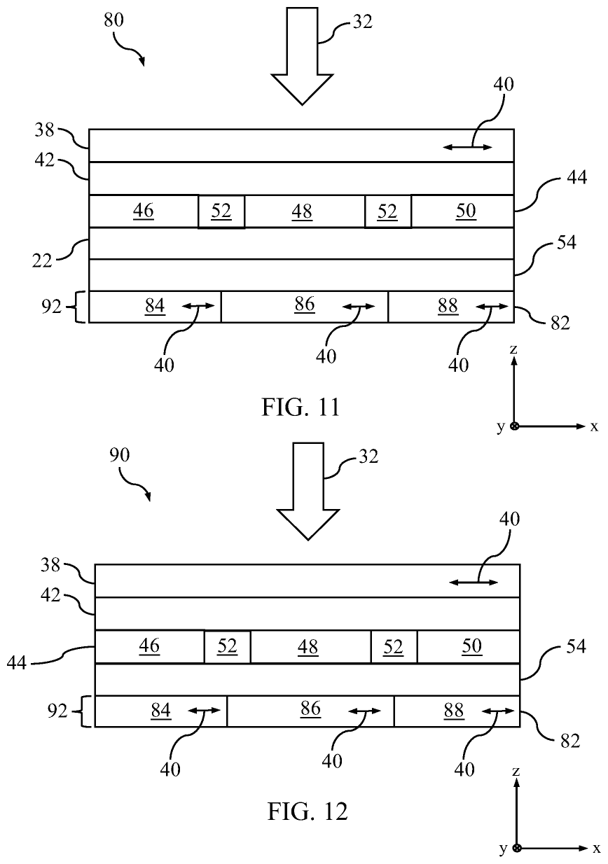

Referring to FIGS. 11-16, various patterned in-cell guest-host polarizer configurations are shown. An advantage of the patterned guest-host polarizer configuration shown in FIGS. 11-16 is reduced color artefacts compared with the unpatterned guest-host polarizers of FIGS. 5-10. Color artefacts arise when the color filter layer-to-LC layer distance is too large; therefore, the reduced thickness of the patterned guest-host polarizer minimizes color artefacts. In other words, color artefacts are reduced because the distance (e.g., a predetermined thickness) 92 (FIGS. 11-16) is less than the predetermined thickness 56 (FIGS. 5-10). One advantage of the unpatterned guest-host polarizer configuration shown in FIGS. 5-10 is lower manufacturing costs compared with the patterned guest-host polarizer of FIGS. 11-16. The patterned in-cell guest-host polarizer layer 82 may have at least 2 different dye components.

FIG. 11 shows part of a first alternative LCD with dye component 80 that has a patterned in-cell guest-host polarizer layer 82. The patterned in-cell guest-host polarizer layer 82 shown in FIG. 11 comprises a red guest-host polarizer layer 84 that polarizes light in the red part of the visible spectrum, and is situated underneath the red color filter 46. The red guest-host polarizer layer 84 may have one dye component. The patterned in-cell guest-host polarizer layer 82 shown in FIG. 11 is also comprised of a green guest-host polarizer layer 86 that polarizes light in the green part of the visible spectrum that is situated underneath the green color filter 48. The green guest-host polarizer layer 86 may have one dye component. The patterned in-cell guest-host polarizer layer 82 shown in FIG. 11 is also comprised of a blue guest-host polarizer layer 88 that polarizes light in the blue part of the visible spectrum, and is situated underneath the blue color filter 50. The blue guest-host polarizer layer 88 may have one dye component.

The transmission axes 40 of the red guest-host polarizer layer 84, green guest-host polarizer layer 86, and blue guest-host polarizer layer 88 are aligned parallel to the x-axis and parallel to the first external linear polarizer 38. The first alternative LCD with dye component 80 shown in FIG. 11 may be combined with other features of the first LCD 36 shown in FIG. 5 or the fourth LCD 74 shown in FIG. 8.

FIG. 12 shows part of a second alternative LCD with dye component 90 that has a patterned in-cell guest-host polarizer layer 82. The second alternative LCD with dye component 90 is identical to the first alternative LCD with dye component 80, except the first electrode layer 22 (FIG. 11) has been removed. The second alternative LCD with dye component 90 shown in FIG. 12 may be combined with other features of the second LCD 68 shown in FIG. 6, the third LCD 70 shown in FIG. 7, the fifth LCD 76 shown in FIG. 9, or the sixth LCD 78 shown in FIG. 10.

An advantage of the patterned in-cell guest-host polarizer layer 82 configuration shown in FIGS. 11 and 12 is reduced color artifacts compared with the unpatterned in-cell guest-host polarizer 14 of FIGS. 5-10. Color artifacts arise when the color filter layer 44 to LC layer 24 distance is too large; therefore, the reduced thickness of the patterned in-cell guest-host polarizer layer 82 minimizes color artefacts. In other words, color artefacts are reduced because the second predetermined thickness 92 is less than the first predetermined thickness 56. An advantage of the unpatterned in-cell guest-host polarizer 14 configuration shown in FIGS. 5-10 is the lower manufacturing costs compared with the patterned guest-host polarizer of FIGS. 11 and 12.

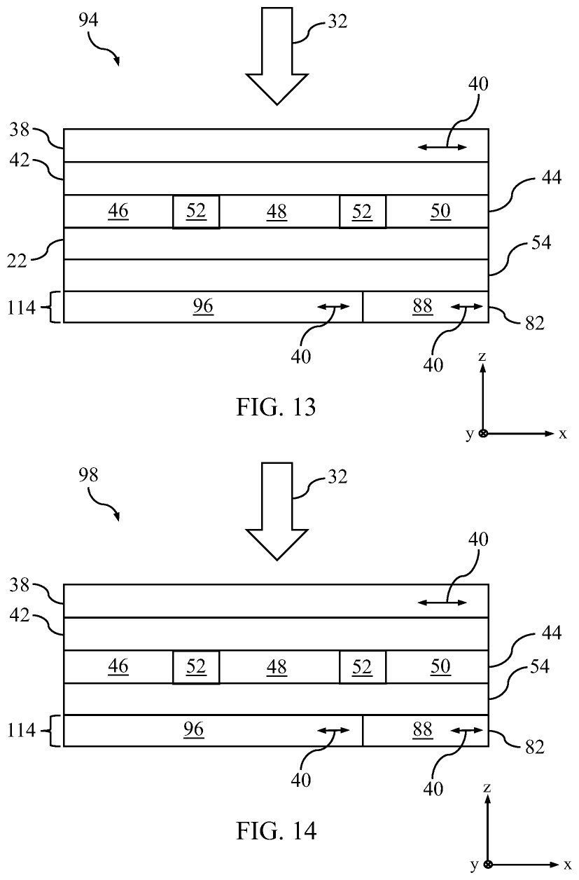

FIG. 13 shows a third alternative LCD with dye component 94 that has a patterned in-cell guest-host polarizer layer 82. In the third alternative LCD with dye component 94, the patterned in-cell guest-host polarizer layer 82 is comprised of a yellow guest-host polarizer layer 96 that polarizes light in the yellow part of the visible spectrum and is situated underneath the red color filter 46 and the green color filter 48. The patterned in-cell guest-host polarizer layer 82 shown in FIG. 13 is also comprised of a blue guest-host polarizer layer 88 that polarizes light in the blue part of the visible spectrum and is situated underneath the blue color filter 50. The transmission axes of the yellow guest-host polarizer layer 96 and the blue guest-host polarizer layer 88 are aligned parallel to the x-axis and parallel to the transmission axis of the first external linear polarizer 38. The third alternative LCD with dye component 94 shown in FIG. 13 may be combined with other features of the first LCD 36 as shown in FIG. 5, the fourth LCD 74 as shown in FIG. 8. The yellow guest-host polarizer layer 96 may have one or more dye components. The third alternative LCD with dye component 94 includes a first electrode layer, similar to the first alternative LCD with dye component 80 of FIG. 11

FIG. 14 shows a fourth alternative LCD with dye component 98 that has a patterned in-cell guest-host polarizer layer 82. In the fourth alternative LCD with dye component 98, the patterned in-cell guest-host polarizer layer 82 is comprised of a yellow guest-host polarizer layer 96 that polarizes light in the yellow part of the visible spectrum and is situated underneath the red color filter 46 and the green color filter 48. The patterned in-cell guest-host polarizer layer 82 shown in FIG. 14 is also comprised of a blue guest-host polarizer layer 88 that polarizes light in the blue part of the visible spectrum and is situated underneath the blue color filter 50. The transmission axes 40 of the yellow guest-host polarizer layer 96 and the blue guest-host polarizer layer 88 are aligned parallel to the x-axis and parallel to the transmission axis of the first external linear polarizer 38. The fourth alternative LCD with dye component 98 as shown in FIG. 14 may be combined with other features of the second LCD 68 shown in FIG. 6, the third LCD 70 as shown in FIG. 7, the fifth LCD 76 as shown in FIG. 9, or the sixth LCD 78 as shown in FIG. 10. The yellow guest-host polarizer layer 96 may have one or more dye components. The fourth alternative LCD with dye component 98 does not include a first electrode layer 22, similar to the second alternative LCD with dye component 90 of FIG. 12.

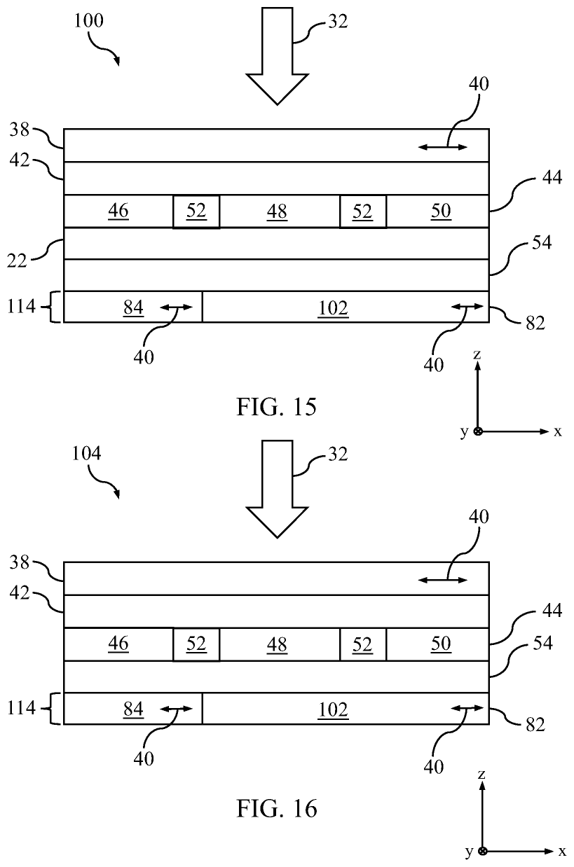

FIG. 15 shows a fifth alternative LCD with dye component 100 that has a patterned in-cell guest-host polarizer layer 82. In the fifth alternative LCD with dye component 100, the patterned in-cell guest-host polarizer layer 82 is comprised of a cyan guest-host polarizer layer 102 that polarizes light in the cyan part of the visible spectrum and is situated underneath the green color filter 48 and the blue color filter 50. The cyan guest-host polarizer layer 102 may have one or more dye components. The patterned in-cell guest-host polarizer layer 82 shown in FIG. 15 is also comprised of a red guest-host polarizer layer 84 that polarizes light in the red part of the visible spectrum that is situated underneath the red color filter 46. The transmission axes 40 of the cyan guest-host polarizer layer 102 and the red guest-host polarizer layer 84 are aligned parallel to the x-axis and parallel to the transmission axis 40 of the first external linear polarizer 38. The fifth alternative LCD with dye component 100 shown in FIG. 15 may be combined with other features of the first LCD 36 shown in FIG. 5 or the fourth LCD 74 shown in FIG. 8.

FIG. 16 shows a sixth alternative LCD with dye component 104 that has a patterned in-cell guest-host polarizer layer 82. In the sixth alternative LCD with dye component 104, the patterned in-cell guest-host polarizer layer 82 is comprised of a cyan guest-host polarizer layer 102 that polarizes light in the cyan part of the visible spectrum and is situated underneath the green color filter 48 and the blue color filter 50. The cyan guest-host polarizer layer 102 may have one or more dye components. The patterned in-cell guest-host polarizer layer 82 shown in FIG. 16 is also comprised of a red guest-host polarizer layer 84 that polarizes light in the red part of the visible spectrum that is situated underneath the red color filter 46. The transmission axes 40 of the cyan guest-host polarizer layer 102 and the red guest-host polarizer layer 84 are aligned parallel to the x-axis and parallel to the transmission axis 40 of the first external linear polarizer 38. The sixth alternative LCD with dye component 104 shown in FIG. 16 may be combined with other features of the second LCD 68 shown in FIG. 6, the third LCD 70 shown in FIG. 7, the fifth LCD 76 shown in FIG. 9, or the sixth LCD 78 shown in FIG. 10.

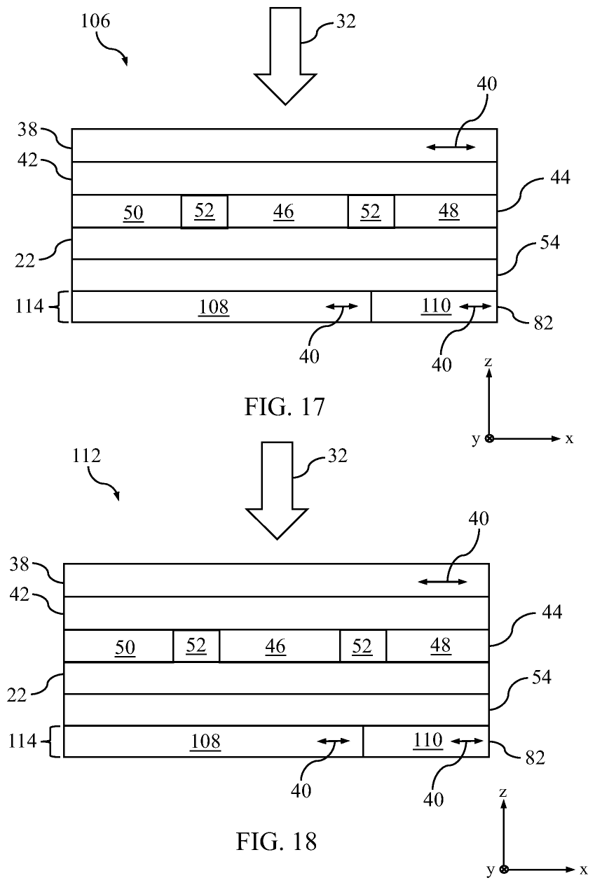

FIG. 17 shows a seventh alternative LCD with dye component 106 that has a patterned in-cell guest-host polarizer layer 82. In the seventh alternative LCD with dye component 106, the patterned in-cell guest-host polarizer layer 82 is comprised of a magenta guest-host polarizer layer 108 that polarizes light in the magenta part of the visible spectrum and is situated underneath the blue color filter 50 and the red color filter 46. The magenta guest-host polarizer layer 108 may have one or more dye components. The patterned guest-host polarizer layer 82 shown in FIG. 17 is also comprised of a green guest-host polarizer layer 110 that polarizes light in the green part of the visible spectrum and is situated underneath the green color filter 48. The transmission axes 40 of the magenta guest-host polarizer layer 108 and the green guest-host polarizer layer 110 are aligned parallel to the x-axis and parallel to the transmission axis 40 of the first external linear polarizer 38. The seventh alternative LCD with dye component 106 shown in FIG. 17 may be combined with other features of the first LCD 36 shown in FIG. 5 or the fourth LCD 74 shown in FIG. 8.

FIG. 18 shows an eighth alternative LCD with dye component 112 that has a patterned in-cell guest-host polarizer layer 82. In the eighth alternative LCD with dye component 112, the patterned in-cell guest-host polarizer layer 82 is comprised of a magenta guest-host polarizer layer 108 that polarizes light in the magenta part of the visible spectrum and is situated underneath the blue color filter 50 and the red color filter 46. The magenta guest-host polarizer layer 108 may have one or more dye components. The patterned guest-host polarizer layer 82 shown in FIG. 18 is also comprised of a green guest-host polarizer layer 110 that polarizes light in the green part of the visible spectrum and is situated underneath the green color filter 48. The transmission axes 40 of the magenta guest-host polarizer layer 108 and the green guest-host polarizer layer 110 are aligned parallel to the x-axis and parallel to the transmission axis 40 of the first external linear polarizer 38. The eighth alternative LCD with dye component 112 shown in FIG. 18 may be combined with other features of the second LCD 68 shown in FIG. 6, the third LCD 70 shown in FIG. 7, the fifth LCD 76 shown in FIG. 9, or the sixth LCD 78 shown in FIG. 10.

Although the implementations in FIGS. 13-18 may have slight color artefacts as compared to the implementations in FIGS. 11 and 12, the implementations in FIGS. 13-18 have lower manufacturing costs than those of FIGS. 11 and 12. The implementations depicting two different types of patterned guest-host polarizer (i.e., those of FIGS. 13-18) are a compromise between the low manufacturing cost offered by the unpatterned in-cell guest-host polarizer 14 implementations of FIGS. 5-10 and the low color artefact advantage offered by implementations that depict three different types of patterned in-cell guest-host polarizer layer 82 as shown in FIGS. 11 and 12.

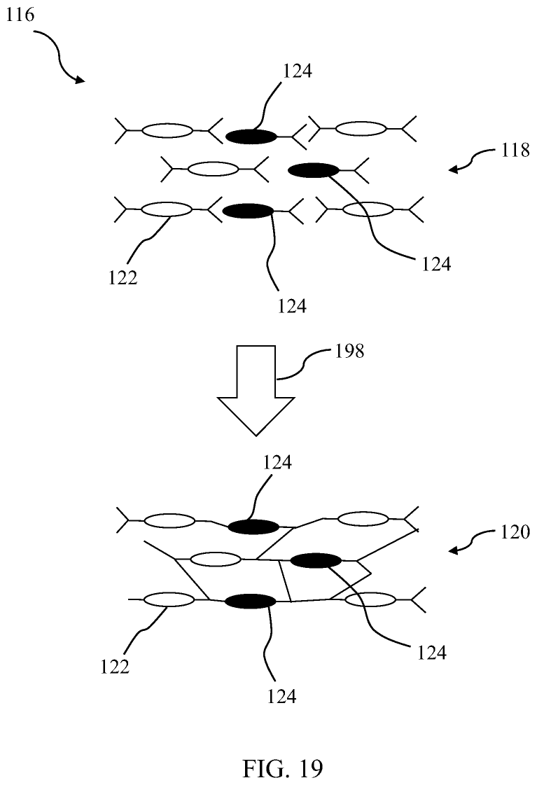

With reference to FIG. 19, a first guest-host polarizer material 116 is shown in a non-polymerized state 118 and a polymerized state 120. The first guest-host polarizer material 116 may be comprised of host molecules 122 with at least one reactive group and guest molecules 124 with at least one reactive group. In general the host molecules 122 may have one, two, or three reactive groups. In general, the guest molecules may have one, two, or three reactive groups. In general, the first guest-host polarizer material 116 may contain a mixture of guest molecules 124 that have one, two, and/or three reactive groups. In general, the first guest-host polarizer material 116 may contain a mixture of host molecules 122 that have one, two, and/or three reactive groups.

Upon illumination by UV radiation 198, the guest molecules 124 and host molecules 122 polymerize forming the polymerized state 120, which is preferably a solid film that is robust to environmental conditions. During polymerization, chemical bonds may be formed between the guest molecules 124, and chemical bonds may be formed between the host molecules 122. Additionally, chemical bonds may be formed between the guest molecules 124 and the host molecules 122. Conventionally, only the host molecules 122 contain reactive groups while the guest molecules 124 do not contain reactive groups. In general, an advantage of both the guest molecules 124 and host molecules 122 containing reactive groups enables a more robust solid guest-host polarizer layer to be formed in the polymerized state 120. In general, an advantage of more reactive groups per molecule (guest molecule 124 and host molecule 122) enables a more mechanically robust in-cell guest-host polarizer layer 14/82 to be formed. An advantage of fewer reactive groups per molecule enables a less shrinkage of the in-cell guest-host polarizer layer 14/82 (FIGS. 5-18) during polymerization. Film shrinkage may be detrimental to the optical performance of the in-cell guest-host polarizer 14/82.

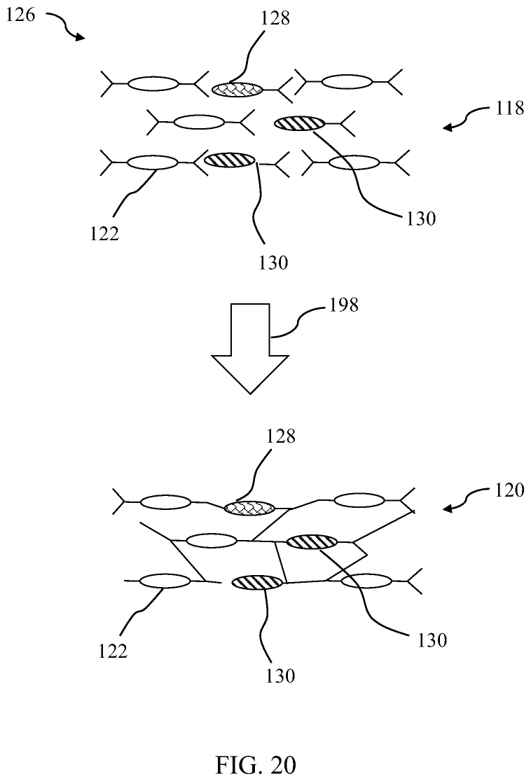

With reference to FIG. 20, a second guest-host polarizer material 126 is shown in a non-polymerized state 118 and a polymerized state 120. The second guest-host polarizer material 126 may be comprised of host molecules 122 and at least a type of first guest molecule 128 and at least a type of second guest molecule 130. The first guest molecule 128 absorbs light polarized parallel to the guest molecule's absorption axis for a first wavelength range wherein the first wavelength range partially, but not fully, covers the visible spectrum. The second guest molecule 130 absorbs light polarized parallel to the guest molecule's absorption axis for a second wavelength range wherein the second wavelength range partially, but not fully, covers the visible spectrum. The first wavelength range and the second wavelength range are different. Upon illumination by UV radiation 198, the first guest molecules 128 and second guest molecules 130, and host molecules 122 polymerize forming a polymerized state 120, which is preferably a solid film that is robust to environmental conditions. The polymerization process and advantages of such a guest-host polarizer layer have been previously described.

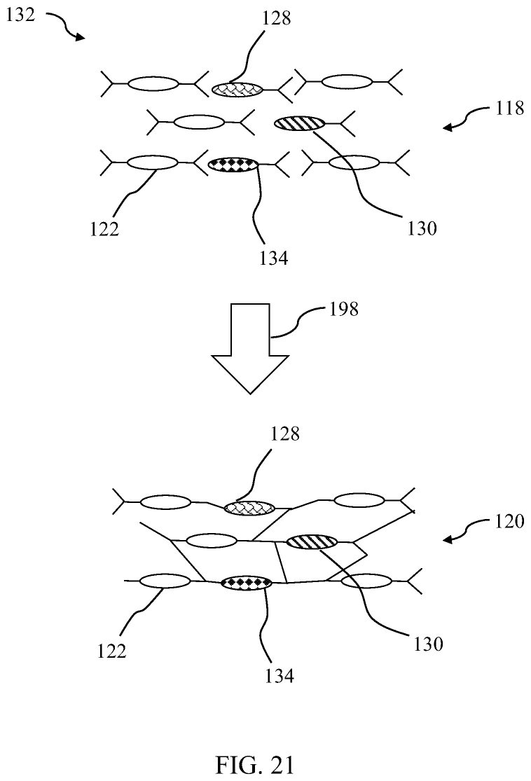

With reference to FIG. 21, a third guest-host polarizer material 132 is shown in a non-polymerized state 118 and a polymerized state 120. The third guest-host polarizer material 132 may be comprised of host molecules 122, at least a type of first guest molecule 128, at least a type of second guest molecule 130, and at least a type of third guest molecule 134. The first guest molecule 128 absorbs light polarized parallel to the guest molecule's absorption axis for a first wavelength range wherein the first wavelength range partially, but not fully, covers the visible spectrum. The second guest molecule 130 absorbs light polarized parallel to the guest molecule's absorption axis for a second wavelength range wherein the second wavelength range partially, but not fully, covers the visible spectrum. The third guest molecule 134 absorbs light polarized parallel to the guest molecule's absorption axis for a third wavelength range wherein the third wavelength range partially, but not fully, covers the visible spectrum. The first wavelength range and the second wavelength range and the third wavelength range are all different. Upon illumination by UV radiation 198, the first guest molecules 128, the second guest molecules 130, the third guest molecules 134, and the host molecules 122 polymerize forming a polymerized state 120 that is robust to environmental conditions. The polymerization process and advantages of such a guest-host polarizer layer have been previously described.

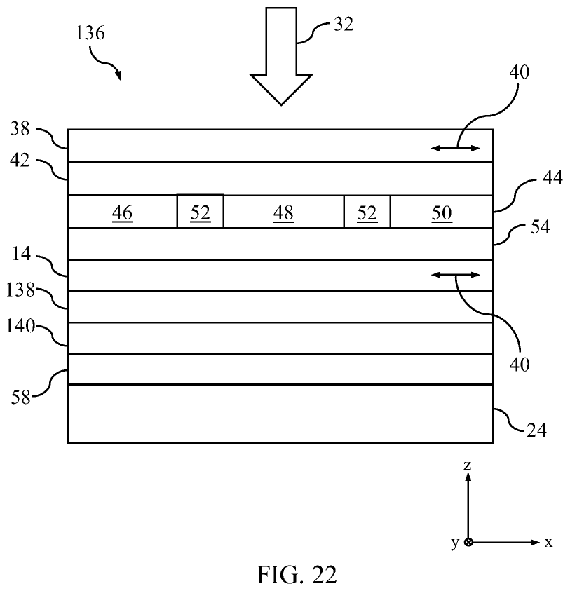

With regard to FIGS. 22-27, the in-cell guest-host polarizer 14 (including the patterned in-cell guest-host polarizer layer 82) may introduce birefringence for light travelling off-axis, which may degrade the image quality of an LCD. Specifically, the birefringence may affect the contrast ratio of an LCD and/or may cause angular dependent color shift. To negate the off-axis birefringence from the in-cell guest-host polarizer layer 14, an additional retarder, or additional retarders, may be used.

With reference to FIGS. 22-25, a first alternative LCD with retarder layer 136, a second alternative LCD with retarder layer 142, a third alternative LCD with retarder layer 144, and a fourth alternative LCD with retarder layer 146 are shown, each having an in-cell retarder layer 140 used to negate the off-axis birefringence from the in-cell guest-host polarizer layer 14. It will be appreciated that in-cell retarder layers 140 may be a single retarder or a combination of multiple retarders. An in-cell retarder alignment layer 138 may be required for each in-cell retarder layer 140, or may be omitted. The first alternative LCD with retarder layer 136 and the third alternative LCD with retarder layer 144 each includes an LC alignment layer 58, while the second alternative LCD with retarder layer 142 and the fourth alternative LCD with retarder layer 146 each omit the LC alignment layer 58.

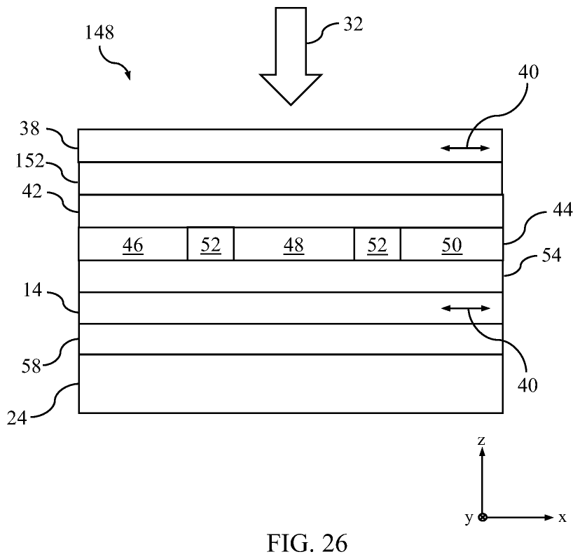

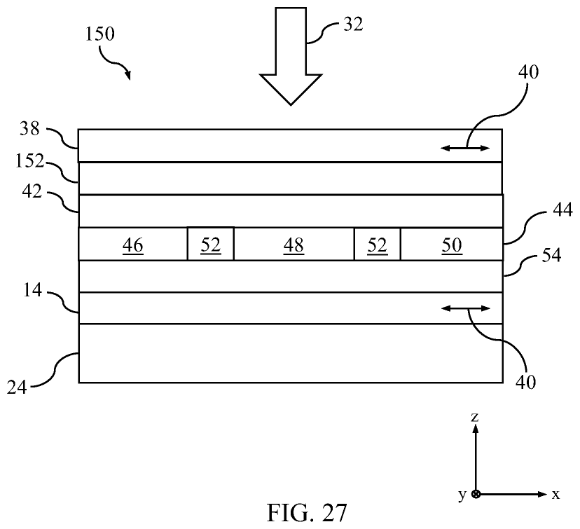

With reference to FIGS. 26 and 27, a fifth alternative LCD with retarder layer 148, and a sixth alternative LCD with retarder layer 150 are shown, each with an out-cell retarder layer 152. Out-cell retarder layers 152 are used to negate the unwanted off-axis birefringence from the in-cell guest-host polarizer layer 14. It will be appreciated that an out-cell retarder layer 152 may be a single retarder or a combination of multiple retarders. The retarder (or retarders) may be of the same birefringence polarity as the in-cell guest-host polarizer layer 14 and the optical axes of the in-cell guest-host polarizer layer 14 and out-cell retarder layers 152 are arranged to be perpendicular. The fifth alternative LCD with retarder layer 148 includes an LC alignment layer 58, while the sixth alternative LCD with retarder layer 150 omits the LC alignment layer 58.

Alternatively, the in-cell retarder layer 140 or out-cell retarder layer 152 may be of opposite birefringence polarity to the in-cell guest-host polarizer layer 14 (including, alternatively, the patterned in-cell guest-host polarizer layer 82) and the optical axes of the in-cell guest-host polarizer layer 14 and in-cell retarder layer 140/out-cell retarder layer 152 are arranged to be parallel.

The in-cell retarder layer 140 (FIGS. 22-25)/out-cell retarder layer 152 (FIGS. 26-27) may be a biaxial half-wave retarder with the condition NZ=(nx−nz)/(nx−ny)=0.5 and the biaxial half-wave retarder has an optical axis that is aligned either parallel or perpendicular to the transmission axis of the in-cell guest-host polarizer layer 14 (including, alternatively, the patterned in-cell guest-host polarizer layer 82). Alternatively, the in-cell retarder layer 140/out-cell retarder layer 152 is comprised of a positive A-plate retarder and a negative A-plate retarder wherein the optical axis of the positive A-plate retarder is arranged perpendicular to the negative A-plate retarder, and, the optical axis of the positive A-plate retarder is further arranged to be either parallel or perpendicular to the transmission axis of the in-cell guest-host polarizer layer 14 (including, alternatively, the patterned in-cell guest-host polarizer layer 82).

Alternatively, the in-cell retarder layer 140/out-cell retarder layer 152 is comprised of a positive A-plate retarder and a positive C-plate retarder wherein the optical axis of the positive A-plate retarder is arranged to be either parallel or perpendicular to the transmission axis of the in-cell guest-host polarizer layer 14 (including, alternatively, the patterned in-cell guest-host polarizer layer 82). Alternatively, the in-cell retarder layer 140/out-cell retarder layer 152 is comprised of a negative A-plate retarder and a negative C-plate retarder wherein the optical axis of the negative A-plate retarder is arranged to be either parallel or perpendicular to the transmission axis of the in-cell guest-host polarizer layer 14 (including, alternatively, the patterned in-cell guest-host polarizer layer 82).

Alternatively, the in-cell retarder layer 140/out-cell retarder layer 152 is comprised of a negative A-plate retarder and a negative C-plate retarder wherein the optical axis of the negative A-plate retarder is arranged to be either parallel or perpendicular to the transmission axis of the in-cell guest-host polarizer layer 14 (including, alternatively, the patterned in-cell guest-host polarizer layer 82).

Alternatively, the in-cell retarder layer 140/out-cell retarder layer 152 is comprised of a first positive A-plate retarder and a positive C-plate retarder and a second positive A-plate retarder wherein the optical axis of the first positive A-plate retarder is perpendicular to the optical axis of the second positive A-plate retarder and the positive C-plate retarder is sandwiched between the first and second positive A-plate retarders and the first positive A-plate retarder is further arranged to be either parallel or perpendicular to the transmission axis of the in-cell guest-host polarizer layer 14 (including, alternatively, the patterned in-cell guest-host polarizer layer 82).

Alternatively, the in-cell retarder layer 140/out-cell retarder layer 152 is comprised of a first negative A-plate retarder and a negative C-plate retarder and a second negative A-plate retarder wherein the optical axis of the first negative A-plate retarder is perpendicular to the optical axis of the second negative A-plate retarder and the negative C-plate retarder is sandwiched between the first and second negative A-plate retarders and the first negative A-plate retarder is further arranged to be either parallel or perpendicular to the transmission axis of the in-cell guest-host polarizer layer (including, alternatively, the patterned in-cell guest-host polarizer layer 82). In general, the in-cell retarder layer 140 or out-cell retarder layer 152 may be comprised of at least one of the following: a biaxial retarder, a positive A-plate retarder, a negative A-plate retarder, a positive C-plate retarder and a negative C-plate retarder wherein an axis of said biaxial retarder is arranged either parallel or perpendicular to the transmission axis of the in-cell guest-host polarizer layer 14 and the axis of the positive and negative A-plate retarder(s) is arranged either parallel or perpendicular to the transmission axis of the in-cell guest-host polarizer layer 14.

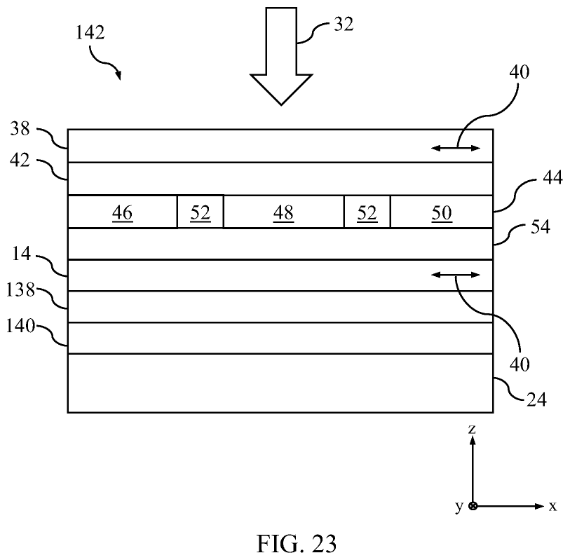

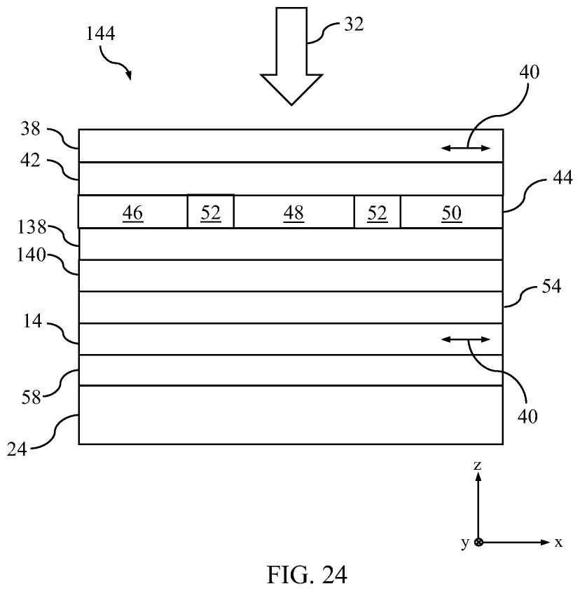

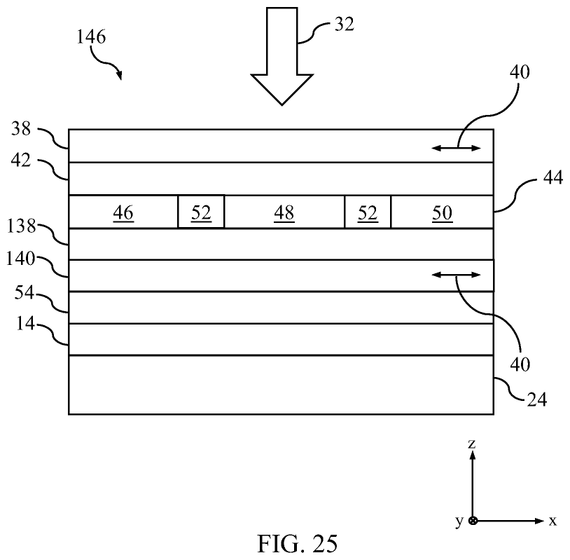

The implementations shown in FIGS. 22-27 may be combined with design features shown in previous embodiments to realize an LCD with an in-cell polarizer. FIGS. 22-27 may have a second electrode layer 26 deposited on the non-viewing side of the CF substrate layer 42 as shown in previous embodiments. With reference to FIG. 22, an LC alignment layer 58 is deposited on the in-cell retarder layer 140 to align the LC layer 24. With reference to FIG. 23, the in-cell retarder layer 140 may be used to align the LC layer 24. With reference to FIG. 24, an LC alignment layer 58 may be deposited on the in-cell guest-host polarizer layer 14 to align the LC layer 24. With reference to FIG. 25, the in-cell guest-host polarizer layer 14 may be used to align the LC layer 24. With reference to FIG. 26, an LC alignment layer 58 may be deposited on the in-cell guest-host polarizer layer 14 to align the LC layer 24. With reference to FIG. 27, the in-cell guest-host polarizer layer 14 may be used to align the LC layer 24.

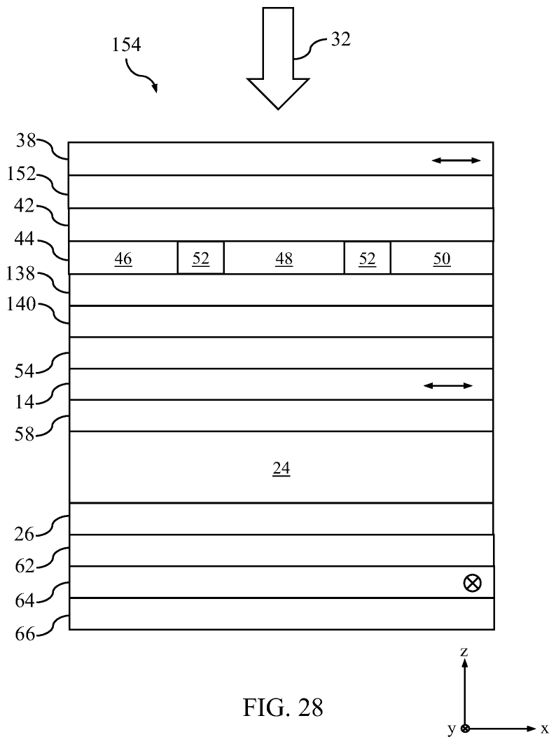

FIG. 28 shows a first alternative high-contrast low-reflectivity LCD 154, which enables high contrast ratio and low reflectivity of ambient lighting. The LCD 154 comprises from the viewing side: a first external linear polarizer 38 with a transmission axis arranged in the x-direction (i.e., azimuth angle ϕ=0°), a quarter wave plate (λ/4) out-cell retarder layer 152 with the optical axis arranged at the azimuth angle ϕ=+45°, a CF substrate layer 42, a patterned color filter layer 44 (comprised of a red color filter 46, a green color filter 48, a blue color filter 50, and black mask 52 that are patterned in a conventional arrangement), a quarter wave plate (λ/4) in-cell retarder alignment layer 138 configured to align a quarter wave plate (λ/4) in-cell retarder layer 140 with the optical axis arranged at an azimuth angle ϕ=−45°, a guest-host polarizer alignment layer 54 that aligns the transmission axis of the in-cell guest-host polarizer 14 parallel to the x-direction (i.e., azimuth angle ϕ=0°), an in-cell guest-host polarizer 14 with transmission axis aligned parallel to the x-direction, a first LC alignment layer 58, an LC layer 24, a second LC alignment layer 26, a TFT substrate 62 (the TFT substrate 62 is comprised of a substrate with a conventional arrangement of TFTs and drive electrodes for switching pixels of the LC layer 24), a second external linear polarizer 64 with transmission axis aligned parallel to the y-direction (i.e., azimuth angle ϕ=0°, and, a backlight unit 66.

The quarter wave plate (λ/4) out-cell retarder layer 152 is a positive A-plate retarder. The quarter wave plate (λ/4) in-cell retarder layer 140 is a positive A-plate retarder. The retardation and dispersion of the quarter wave plate (λ/4) out-cell retarder layer 152 is the same, or substantially the same (i.e., within 20%), as the quarter wave plate (λ/4) in-cell retarder layer 140. The LCD 154 may have similar electrode layer structures (not shown) and a similar insulator layer structure as disclosed by FIGS. 5 through 10 inclusive. The LCD 154 may have similar LC alignment arrangements as disclosed by FIGS. 5 through 10 inclusive. The LCD 154 may have similar in-cell guest-host polarizer 14 arrangements as shown by FIGS. 11 through 18 inclusive. Alternatively, the in-cell guest-host polarizer 14 layer may be a lyotropic LC polarizer.

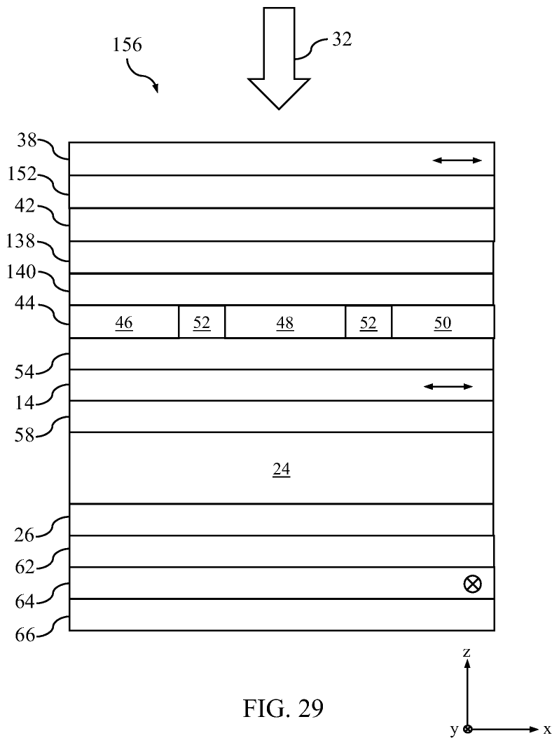

FIG. 29 shows a second alternative high-contrast low-reflectivity LCD 156 that is similar to first alternative high-contrast low-reflectivity LCD 154. The difference between the first alternative high-contrast low-reflectivity LCD 154 and the second alternative high-contrast low-reflectivity LCD 156 is the ordering of the patterned color filter layer 44, quarter wave plate (λ/4) in-cell retarder alignment layer 138 and quarter wave plate (λ/4) in-cell retarder layer 140. The second alternative high-contrast low-reflectivity LCD 156 may enable higher contrast ratio in a dark room compared to the first alternative high-contrast low-reflectivity LCD 154. The first alternative high-contrast low-reflectivity LCD 154 may enable lower reflection of ambient lighting than the second alternative high-contrast low-reflectivity LCD 156.

What is claimed is:

1. A viewable liquid crystal display (LCD) apparatus exhibiting increased image contrast, the apparatus comprising from a viewing side:
a first external linear polarizer layer having a transmission axis aligned along in a first direction;
a color filter substrate layer;
a patterned color filter layer, the pattern comprising individual color filters;
a guest-host in-cell polarizer alignment layer;
an in-cell guest-host polarizer layer having a transmission axis aligned along the first direction;
a first liquid crystal (LC) alignment layer;
an LC layer;
a second LC alignment layer;
a first electrode layer;
a thin film transistor (TFT) substrate layer;
a second external polarizer layer having a transmission axis aligned along a second direction perpendicular to the first direction; and
a backlight unit configured for illuminating the LCD apparatus.

2. The viewable LCD apparatus of claim 1 wherein the first LC alignment layer is configured for a baking process temperature of below 180° C.

3. The viewable LCD apparatus of claim 1, wherein the first electrode layer comprises a first electrode and a second electrode.

4. The viewable LCD apparatus of claim 1, further comprising a second electrode layer, wherein:
the LC layer disposed between the first electrode layer and the second electrode layer; or
the first electrode layer is disposed between the LC layer and the second electrode layer.

5. The viewable LCD apparatus of claim 1, wherein the in-cell guest-host polarizer layer is patterned with individual dye components, the dye components aligned with the color filters of the patterned color filter layer.

6. The viewable LCD apparatus of claim 5, wherein an individual dye component aligns across two or more color filters.

7. The viewable LCD apparatus of claim 1, wherein the in-cell guest-host polarizer layer comprises:
a material having multiple guest reactive groups and multiple host reactive groups, or
a material having a plurality of guest molecules.

8. The viewable LCD apparatus of claim 7, wherein the plurality of guest molecules is individually configured to absorb polarized light in a plurality of wavelengths.

9. The viewable LCD apparatus of claim 1, further comprising an in-cell retarder layer or an out-cell retarder layer configured to negate off-axis birefringence from the in-cell guest-host polarizer layer.

10. The viewable LCD apparatus of claim 1, further comprising an out-cell quarter wave plate (λ/4) retarder having an optical axis arranged at an azimuth angle ϕ=+45° and an in-cell quarter wave plate (λ/4) retarder having an optical axis arranged at an azimuth angle ϕ=−45°, wherein the retardation and dispersion of the out-cell quarter wave plate retarder and the in-cell quarter wave plate retarder are substantially the same.

11. A viewable liquid crystal display (LCD) apparatus exhibiting increased contrast, the apparatus comprising from a viewing side:
a first external polarizer having a transmission axis arranged in a first direction;
a color filter substrate;
a patterned color filter layer, the pattern comprising individual color filters;
an in-cell guest-host polarizer alignment layer;
an in-cell guest-host polarizer layer having a transmission axis aligned along the first direction;
a liquid crystal (LC) layer, wherein the in-cell guest-host polarizer layer is configured to align the LC layer;
an LC alignment layer;
a first electrode layer;
a thin film transistor (TFT) substrate layer;
a second external polarizer layer having a transmission axis arranged in a second direction perpendicular to the first direction; and
a backlight unit, wherein the in-cell guest-host polarizer layer and the alignment layer together align the LC layer.

12. The viewable LCD apparatus of claim 11, wherein the first electrode layer comprises a first electrode and a second electrode.

13. The viewable LCD apparatus of claim 11, further comprising a second electrode layer, wherein:
the LC layer disposed between the first electrode layer and the second electrode layer; or
the first electrode layer is disposed between the LC layer and the second electrode layer.

14. The viewable LCD apparatus of claim 11, wherein the in-cell guest-host polarizer layer is patterned with individual dye components, the dye components aligned with the color filters of the patterned color filter layer.

15. The viewable LCD apparatus of claim 11, wherein an individual dye component aligns across two or more color filters.

16. The viewable LCD apparatus of claim 11, wherein the in-cell guest-host polarizer layer comprises a material having guest reactive groups and host reactive groups.

17. The viewable LCD apparatus of claim 11, wherein the in-cell guest-host polarizer layer comprises a material having a plurality of guest molecules.

18. The viewable LCD apparatus of claim 17, wherein the plurality of guest molecules is individually configured to absorb polarized light in a plurality of wavelengths.

19. The viewable LCD apparatus of claim 11, further comprising a retarder layer chosen from the list consisting of a biaxial retarder, a positive A-plate retarder, a negative A-plate retarder, a positive C-plate retarder, and a negative C-plate retarder.

20. The viewable LCD apparatus of claim 19, wherein an axis of said biaxial retarder is arranged either parallel or perpendicular to the transmission axis of the guest-host polarizer layer, wherein an axis of the positive A-plate retarder(s) is arranged either parallel or perpendicular to the transmission axis of the guest-host polarizer layer, and wherein an axis of the negative A-plate retarder(s) is arranged either parallel or perpendicular to the transmission axis of the guest-host polarizer layer.
